(19) United States
(12) Patent Application Publication
(10) Pub. No.: US 2025/0076189 A1
(43) Pub. Date: Mar. 6, 2025

(54) METHOD AND APPARATUS FOR SPECTRAL IMAGING

(71) Applicant: Teknologian tutkimuskeskus VTT Oy, Espoo (FI)

(72) Inventors: Jussi SOUKKAMÄKI, Espoo (FI); Teemu KÄÄRIÄINEN, Espoo (FI)

(73) Assignee: Teknologian tutkimuskeskus VTT Oy, Espoo (FI)

(21) Appl. No.: 18/819,095

(22) Filed: Aug. 29, 2024

(30) Foreign Application Priority Data
Sep. 4, 2023 (FI) 20235986

(51) Int. Cl. G01N 21/31

(52) U.S. Cl. CPC G01N 21/31; G01N 2201/06113; G01N 2201/0636

(57) ABSTRACT

An apparatus for spectral imaging comprises:
an illuminating unit to illuminate a linear region of an object with a linear pattern formed from a narrowband light pulse,
a line scan camera to capture an image of the illuminated linear region,
   wherein the illuminating unit comprises:
a light source to generate broadband light pulses,
a tunable Fabry-Perot interferometer to form the narrowband light pulse by filtering a broadband light pulse,
beam-shaping optics to form the linear pattern from the narrowband light pulse, the wavelength of the linear pattern being determined by the mirror gap of the Fabry-Perot interferometer,
   wherein the apparatus is arranged to change the mirror gap of the Fabry-Perot interferometer.

### FIELD

The present invention relates to spectral imaging.

### BACKGROUND

In a typical pushbroom hyperspectral camera, only one spatial line of a moving object is imaged at a time. The imaged line is transmitted through a dispersing element (e.g. a diffraction grating), which decomposes the multicolor line into a plurality of spatially separate monochromatic lines. The spatially separate monochromatic lines are captured by using an image sensor, which comprises a two-dimensional array of light-detecting pixels. One dimension (x-axis) of a single captured image represents the spatial dimension of the object, and the other orthogonal dimension (y-axis) of the captured image represents the spectral dimension.

The typical pushbroom hyperspectral camera images a single linear region of the object at a time. Data from a larger area of the object may be gathered when the object moves with respect to the linear field-of view of the camera. Data of linear images captured at different times may be combined to form a hyperspectral image cube, which represents the spectral information of the larger area of the moving object.

The image captured by the two-dimensional image sensor may represent the whole spectrum of the object between a minimum wavelength and a maximum wavelength. However, capturing the whole spectrum with the two-dimensional image sensor may be time-consuming for certain applications, where the spectral intensities need to be measured only at a few different wavelengths.

The operation of the typical pushbroom hyperspectral camera requires typically that the object is illuminated with broadband illumination, which simultaneously comprises all wavelengths of the hyperspectral image cube. Consequently, the broadband illumination may cause an unwanted heat load to the object.

### SUMMARY

An object is to provide an apparatus for spectral imaging. An object is to provide a method for spectral imaging.

According to an aspect, there is provided an apparatus (500) for spectral imaging, comprising:
an illuminating unit (110) to illuminate a linear region (REG1) of an object (OBJ1) with a linear pattern (PAT1) formed from a narrowband light pulse (B2), and
a line scan camera (CAM1) to capture an image (IMG1_{λ}) of the illuminated linear region (REG1),
   wherein the illuminating unit (110) comprises:
a light source (LS1) to generate broadband light pulses (B1),
a tunable Fabry-Perot interferometer (FPI1) to form the narrowband light pulse (B2) by filtering a broadband light pulse (B1),
beam-shaping optics (OPT1) to form the linear pattern (PAT1) from the narrowband light pulse (B2), the wavelength (λ) of the linear pattern (PAT1) being determined by the mirror gap (d_{GAP}) of the Fabry-Perot interferometer (FPI1), and wherein the apparatus (500) is arranged to change the mirror gap (d_{GAP}) of the Fabry-Perot interferometer (FPI1).

According to an aspect, there is provided a method for spectral imaging, comprising:
generating broadband light pulses,
forming a narrowband light pulse from a broadband light pulse by using a tunable Fabry-Perot interferometer,
forming a linear pattern from the narrowband light pulse by using beam-shaping optics,
illuminating a linear region of an object with the linear pattern,
capturing an image of the illuminated linear region, and
changing the mirror gap of the Fabry-Perot interferometer.

The apparatus forms a sequence of illuminating linear patterns at different wavelengths. The linear patterns may be projected onto a moving object. Each linear pattern may have a different wavelength and may illuminate a different linear region of the moving object. The line scan camera may capture images of the illuminated linear regions in synchronized manner so that each captured image may represent a different wavelength.

The Fabry-Perot interferometer may be scanned over a spectral scanning range, and data of the captured images may be combined to form a two-dimensional data matrix, where a first dimension of the data matrix represents a transverse spatial dimension of the object, and the second orthogonal dimension of the data matrix represents the spectral dimension, and also the longitudinal spatial dimension of the object in the direction of the movement of the object.

The Fabry-Perot interferometer may subsequently be scanned over the same spectral scanning range several times, so as to measure the spectrum for several different longitudinal areas of the object. The Fabry-Perot interferometer may be scanned over the same spectral scanning range several times, so that data of the captured images may be combined to form a three-dimensional data matrix, which may also be called as the hyperspectral data cube. The hyperspectral data cube is a three-dimensional data matrix, where a first dimension of the cube represents the transverse spatial direction of the object, a second dimension represents the longitudinal spatial direction of the object, and the third direction represents the spectral dimension, i.e. the wavelength.

The apparatus may be a hyperspectral pushbroom camera arrangement, which provides spectrally selective illumination. The apparatus may be implemented with simple optics. The spectral bands which are used for imaging may be freely selectable (e.g. programmable). The apparatus may be arranged to compensate effects of background illumination. A heating effect of the illuminating light on the object may be reduced.

The apparatus does not necessarily require complex optics. The apparatus may be cheaper. The apparatus may have better tolerance for changes of background illumination. The apparatus may be implemented e.g. by using an off-the-shelf camera. The apparatus may reduce the heat load on the object.

For example, the apparatus may be arranged to measure intensity values at at least four wavelengths during a scanning time period, which may be e.g. shorter than 10 ms.

The apparatus comprises an illuminating unit, which in turn comprises a tunable Fabry-Perot interferometer. The Fabry-Perot interferometer comprises a first semi-transparent mirror and a second semi-transparent mirror. The second semi-transparent mirror is arranged to move with respect to the first mirror.

The wavelength of the passband of the Fabry-Perot interferometer depends on the mirror gap. The mirror gap means the distance between the semi-transparent mirrors of the Fabry-Perot interferometer. The tunable Fabry-Perot interferometer may comprise one or more piezoelectric or electrostatic actuators for changing the mirror gap. The Fabry-Perot interferometer may comprise one or more actuators to move the second mirror with respect to the first mirror.

The illuminating unit comprises a light source to generate broadband light pulses. The light source may be e.g. a laser light source. The light source may be e.g. a supercontinuum light source. The Fabry-Perot interferometer may receive the broadband light pulses from the pulsed broadband light source. The Fabry-Perot interferometer may form narrowband light pulses from the received broadband light pulses. The Fabry-Perot interferometer may form the narrowband light pulses by filtering the received broadband light pulses according to the passband of the Fabry-Perot interferometer. A part of the received light may pass through the Fabry-Perot interferometer at the wavelength of the passband. The wavelength of the passband is determined by the mirror gap of the Fabry-Perot interferometer. Consequently, also the wavelength of a formed narrowband light pulse is determined by mirror gap, at the time when the Fabry-Perot interferometer forms the narrowband light pulse from a received broadband light pulse.

The wavelength of the narrowband light pulses may be changed by changing the mirror gap. The mirror gap may be changed e.g. according to a sinusoidal function. The mirror gap may be changed e.g. according to a sawtooth function. By varying the mirror gap, the illuminating unit may provide a sequence of narrowband light pulses, which have different wavelengths.

The illuminating unit comprises beam-shaping optics to form an illuminating linear pattern from the light of a narrow light pulse. The beam-shaping optics may comprise e.g. a cylindrical lens. A linear region of an object may be illuminated with the linear pattern. By varying the mirror gap, the illuminating unit may provide a sequence of illuminating linear patterns, which have different wavelengths. The intensity of the illuminating linear pattern is concentrated to the narrow bandwidth and to the linear region, so that the signal-to-noised ratio may be maximized and/or the amount of wasted power may be minimized. The intensity of the illuminating pattern is high. Consequently, problems caused by stray light, background illumination, and/or noise of electronics may be reduced.

The apparatus comprises a line scan camera to capture an image of the illuminated linear region of the object. The field-of-view of the line scan camera overlaps the illuminated linear region of the object. The field-of-view of the line scan camera may substantially coincide with the illuminated linear region of the object.

The active area of the image sensor of the camera may has a linear shape. There is no need to obtain image data from regions, which are outside the illuminated region. The line scan camera may be arranged to capture e.g. more than 100 images per second, or even more than 1000 images per second. The image sensor of the line scan camera may comprise only one row of detector pixels. The line scan camera may be faster, smaller and/or less complex than a camera which comprises a two-dimensional image detector.

The illuminating unit may form a sequence of narrowband light pulses at different wavelengths. The object may be sequentially illuminated with the linear patterns, which have the different wavelengths. The line scan camera may capture images of the illuminated regions of the object. Capturing of the images may be synchronized with the timing of the narrowband light pulses. Each captured image may represent a different wavelength of the illuminating pattern.

The repetition rate of the light pulses may be e.g. 100 kHz. The Fabry-Perot interferometer may be scanned over the same spectral scanning range e.g. 1000 times per second. The scanning time period for scanning over the spectral scanning range may be 1 ms, respectively. The illuminating unit may form 100 narrowband light pulses at different wavelengths during the scanning time period of 1 ms. The line scan camera may be arranged to capture the images of illuminated linear regions of the object at the rate of 100 kHz. Thus, the apparatus may gather 100 images of the illuminated regions during the scanning time period of 1 ms, wherein each captured image may represent a different wavelength. In case of a moving object, each captured image may represent a different linear region of the object.

The Fabry-Perot interferometer may be scanned over the same spectral scanning range several times, so as to measure the spectrum for several different longitudinal areas of the object. Data from the captured images may be combined to form a hyperspectral data cube.

The use of the Fabry-Perot interferometer may facilitate measuring the intensity of the generated narrowband light pulses, as all generated light pulses may propagate along the same optical path. The intensity of the generated broadband or narrowband light pulses may be measured e.g. by coupling a part of the light of the light pulses to a detector via a beam splitter. The measured intensity may be used e.g. as feedback to stabilize the intensity of the generated narrowband light pulses and/or to compensate an effect of varying intensity to the captured images.

The wavelengths of the narrowband light pulses may be freely selectable. The wavelengths may be selected according to the specific application. Gathering of useless data may be avoided by a suitable selection of the wavelengths of the narrowband light pulses. Processing of useless data may be avoided by a suitable selection of the wavelengths of the narrowband light pulses.

The apparatus may also be arranged to capture one or more dark images, e.g. to compensate an effect of background illumination. The apparatus may also be arranged to capture one or more dark images, e.g. to compensate an effect of dark current of the image sensor of the line scan camera.

The line scan camera may capture a dark image e.g. when the object is not illuminated with a linear pattern. The line scan camera may capture a dark image e.g. when the object is illuminated with a linear pattern, but the wavelength of the linear pattern is outside the spectral detection range of the line scan camera.

The apparatus may comprise an actuator unit to cause relative movement between the object and the illuminating pattern. The apparatus may comprise e.g. a conveyor belt to cause relative movement between the object and the illuminating pattern. The apparatus may comprise e.g. a robot to cause relative movement between the object and the illuminating pattern. The apparatus may comprise e.g. a motion system to cause relative movement between the object and the illuminating pattern.

The apparatus may be arranged to capture spectral images of an object, which moves on a conveyor belt. The apparatus may be arranged to capture spectral images of an object, which moves on a production line. The apparatus may be mounted on a vehicle, and the apparatus may be arranged to capture spectral images of an object. The apparatus may be mounted on an aerial vehicle, and the apparatus may be arranged to capture spectral images of an object, which is located on the ground.

The apparatus may be arranged e.g. to recognize materials in a recycling process. The apparatus may be arranged e.g. to recognize materials in food industry. The apparatus may be arranged e.g. to monitor quality of a material in food industry.

### BRIEF DESCRIPTION OF THE DRAWINGS

In the following examples, several variations will be described in more detail with reference to the appended drawings, in which

FIG. 1a shows, by way of example, a spectral imaging apparatus,

FIG. 1b shows, by way of example, a row of detector pixels of the image sensor of the line scan camera,

FIG. 1c shows, by way of example, image pixels of an image captured by the row of detector pixels,

FIG. 2a shows, by way of example, in a three-dimensional view, the spectral imaging apparatus,

FIG. 2b shows, by way of example, in a three-dimensional view, the spectral imaging apparatus,

FIG. 3 shows, by way of example, determining reflectance values from image pixels by using calibration data,

FIG. 4a shows, by way of example, a light source for generating broadband light pulses,

FIG. 4b shows, by way of example, the spectrum of broadband light pulses,

FIG. 4c shows, by way of example, timing and duration of light pulses,

FIG. 5a shows, by way of example, forming light pulses of different wavelengths,

FIG. 5b shows, by way of example, forming light pulses of different wavelengths,

FIG. 6a shows, by way of example, a Fabry-Perot interferometer positioned in a vacuum chamber,

FIG. 6b shows, by way of example, a Fabry-Perot interferometer, which is arranged to operate in a gas,

FIG. 7 shows, by way of example, captured images, which represent different wavelengths,

FIG. 8 shows, by way of example, captured images, and a dark image,

FIG. 9a shows, by way of example, a first row of detector pixels, and a second row of detector pixels,

FIG. 9b shows, by way of example, in a three-dimensional view, the field-of view of the first row of detector pixels, and the field-of view of the second row of detector pixels,

FIG. 10a shows, by way of example, images captured by using two rows of detector pixels,

FIG. 10b shows, by way of example, images captured by the first row of detector pixels, and dark images captured by the second row of detector pixels,

FIG. 11a shows, by way of example, two spectral transmittance peaks of the Fabry-Perot interferometer,

FIG. 11b shows, by way of example, an optical filter of the first row of detector pixels, and an optical filter of the second row of detector pixels,

FIG. 11c shows, by way of example, images captured by the two rows of FIG. 11b,

FIG. 12 shows, by way of example, in a top view, spatial intensity distribution of a linear pattern,

FIG. 13a shows, by way of example, in a top view, the position of field-of-view of the line scan camera with respect to the illuminated region on the object,

FIG. 13b shows, by way of example, in a top view, the position of field-of-view of the line scan camera with respect to the illuminated region on the object,

FIG. 14a shows, by way of example, spatial intensity distribution of the illuminating pattern at a first wavelength, and spatial intensity distribution of the illuminating pattern at a second wavelength,

FIG. 14b shows, by way of example, in a three-dimensional view, obtaining calibration data by illuminating a reference surface with the linear pattern, and an capturing image of the illuminated region, and

FIG. 15 shows, by way of example, in a side view, an arrangement for measuring the intensity of generated light pulses.

### DETAILED DESCRIPTION

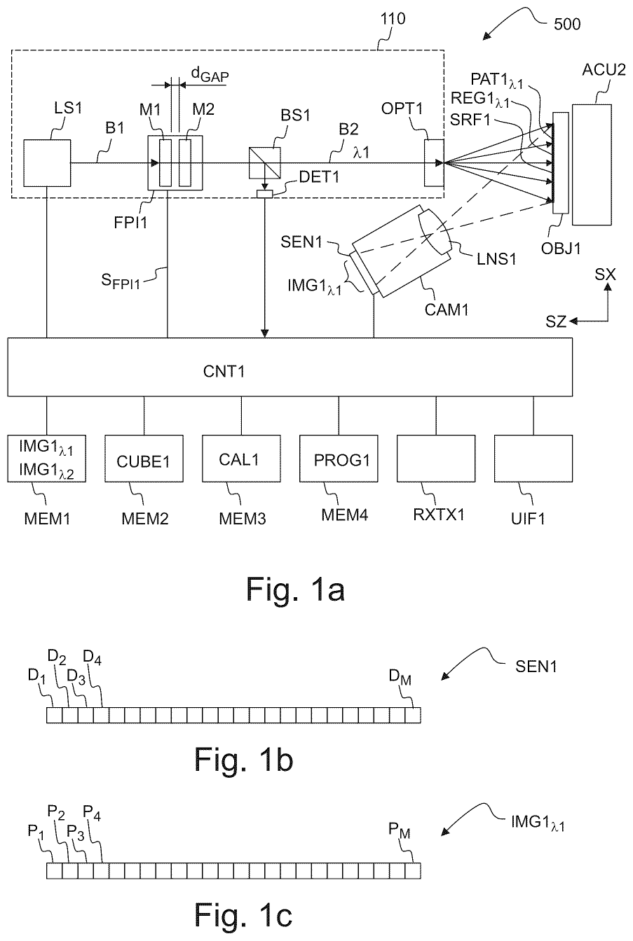

Referring to FIG. 1, the apparatus 500 comprises a broadband light source LS1, a Fabry-Perot interferometer FPI1, a beam shaping optics OPT1, and a line scan camera CAM1.

The apparatus 500 may illuminate an object OBJ1 with a linear pattern PAT1. In particular, the apparatus 500 may illuminate the surface SRF1 of an object OBJ1 with a linear pattern PAT1.

The broadband light source is arranged to generate broadband light pulses at a repetition rate, which may be e.g. greater than or equal to 1 kHz, greater than or equal to 10 kHz, or even greater than or equal to 100 kHz. The repetition rate may be e.g. substantially equal to 100 kHz.

The Fabry-Perot interferometer FPI1 forms narrowband light pulses by filtering the broadband light pulses. The second mirror of the Fabry-Perot interferometer FPI1 may be moved by one or more actuators (ACU1) in order to change the mirror gap d_{GAP} and in order to change the wavelength of the generated narrowband light pulses B2. The mirror gap d_{GAP} denotes the distance between the semi-transparent mirrors M1, M2 of the Fabry-Perot interferometer FPI1.

The apparatus 500 may be arranged to provide a control signal S_{FPI1} indicative of the mirror gap d_{GAP}. The apparatus 500 may be arranged to determine the wavelength of each generated light pulse based on the signal S_{FPI1}. The mirror gap d_{GAP} may be changed according to the control signal S_{FPI1}.

The Fabry-Perot interferometer FPI1 may be positioned in a vacuum chamber, e.g. in order to increase the scanning speed of the Fabry-Perot interferometer FPI1. The absolute pressure in the vacuum chamber may be e.g. smaller than 10 kPa (less than 100 mbar).

The apparatus 500 may optionally comprise a beam splitter BS1, and a reference detector DET1 to measure the energy and/or intensity of the light pulses. The beam splitter BS1 may couple a part of the light of the light pulses to the reference detector DET1. The reference detector DET1 may measure the energy and/or intensity of light pulses received from the beam splitter BS1.

The beam shaping optics OPT1 may form the illuminating linear pattern PAT1 from a narrowband light pulse B2, which has passed through the Fabry-Perot interferometer. The apparatus 500 may illuminate a linear region of the object OBJ1 with the linear pattern PAT1. The apparatus 500 may illuminate a linear region REG1 of the surface of the object OBJ1 with the linear pattern PAT1.

The beam shaping optics OPT1 may form the illuminating linear pattern PAT1, which has a wavelength (λ), which is determined by the wavelength (λ) of a spectral transmittance peak of the Fabry-Perot Interferometer (FPI1). The object OBJ1 may be illuminated with the linear pattern PAT1, which has the wavelength (λ).

Each linear pattern PAT1 may have a different wavelength and may illuminate a different linear region REG1 of the object OBJ1. The apparatus 500 comprises the line scan camera CAM1 to capture images of the illuminated linear regions REG1 of the object. The object OBJ1 may reflect, scatter and/or transmit light towards the line scan camera CAM1. The line scan camera CAM1 may capture images of the illuminated linear regions of the surface SRF1 of the object.

The illuminating linear pattern PAT1 is formed from a narrowband light pulse B2 by using beam shaping optics OPT1. The line shaping optics OPT1 may comprise e.g. a Powell lens to form the linear pattern PAT1 from a narrowband light pulse B2. The line shaping optics OPT1 may comprise e.g. a diffractive optical element to form the linear pattern PAT1 from a narrowband light pulse B2. The beam shaping optics may comprise e.g. a cylindrical lens. The beam shaping optics may also comprise e.g. a first cylindrical lens and a second cylindrical lens. The first cylindrical lens may form e.g. a diverging light beam, and the second cylindrical lens may form a collimated light beam from the diverging light beam.

Referring to FIG. 1b, the image sensor SEN1 of the line scan camera CAM1 may comprise only one active row of detector pixels D₁, D₂, D₃, D₄, . . . D_{M}. Image data may be read from the single row at a very high rate.

The image sensor (SEN1) of the line scan camera (CAM1) may comprise only one active row of detector pixels (D). The image sensor SEN1 of the line scan camera CAM1 may comprise e.g. a 1×M linear array of active light-detecting pixels. The number M may be e.g. in the range of 50 to 10000. The number of detector pixels D of a row may be e.g. in the range of 50 to 10000. The number of detector pixels D of a row may be 128, 256, 512, 1024, 2048, or 4096.

The apparatus 500 may comprise a control unit CNT1 to control operation of the apparatus 500. The control unit CNT1 may e.g. provide a control signal S_{FPI1} for changing the mirror gap d_{GAP}. The control unit CNT1 may be configured to perform data processing operations.

The apparatus 500 may comprise a memory MEM1 for storing captured spectral images IMG1_{λ1}, IMG1_{λ2}.

The apparatus 500 may comprise a memory MEM2 for storing data values, which are determined from the captured spectral images IMG1_{λ1}, IMG1_{λ2}. For example, the control unit CNT1 may be configured to determine a hyperspectral data cube CUBE1 from image data of captured spectral images IMG1_{λ1}, IMG1_{λ2}. The apparatus 500 may comprise a memory MEM2 for storing the determined data values (e.g. CUBE1).

The control unit CNT1 may be configured to determine a hyperspectral data cube CUBE1 from image data e.g. by using calibration data CAL1. The apparatus 500 may comprise a memory MEM3 for storing calibration data CAL1.

The control unit CNT1 may be configured to carry out method steps of spectral imaging by executing program code PROG1. The apparatus 500 may comprise a memory MEM4 for storing the program code PROG1.

The apparatus 500 may comprise a communication unit RXTX1 for receiving and/or transmitting data. The communication unit RXTX1 may communicate e.g. by wired or wireless communication. The communication unit RXTX1 may communicate e.g. with a control system of an industrial process. The communication unit RXTX1 may also communicate e.g. via the Internet.

The apparatus 500 may comprise a user interface UIF1 to provide information to a user and/or to receive user input from the user. The user interface UIF1 may comprise e.g. a touchscreen.

FIG. 1c shows an image IMG1 captured by the image sensor SEN1 of FIG. 1b. The image comprises image pixels P₁, P₂, P₃, P₄, . . . P_{M}. The captured image IMG1_{λ1} represents the wavelength of the illuminating pattern PAT1 at the time of capturing of the image. The captured image IMG1_{λ1} may represent e.g. the wavelength λ1.

The image sensor SEN1 of the line scan camera CAM1 may capture a one-dimensional spectral image IMG1, which comprises a 1×M array of image pixels P₁, P₂, P₃, P₄, . . . P_{M}.

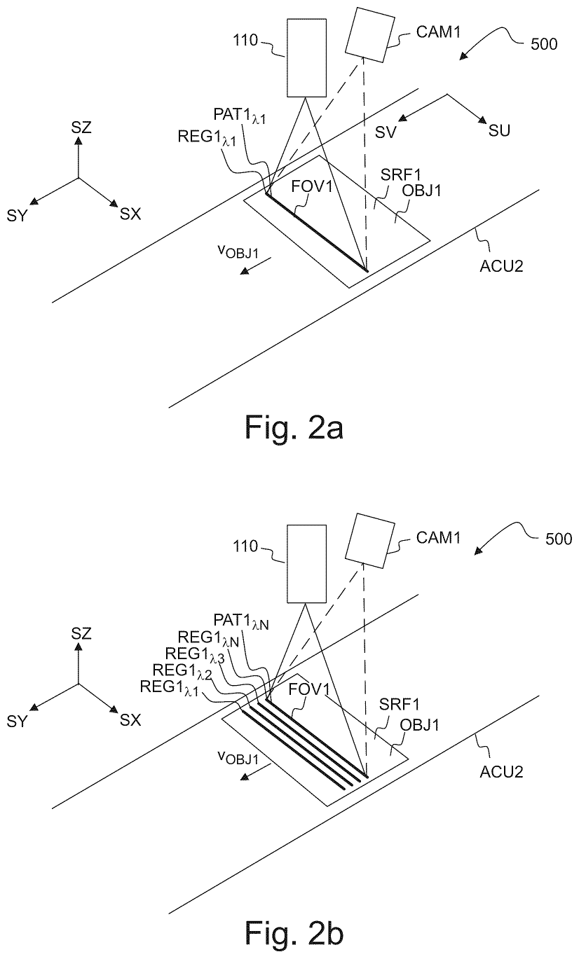

Referring to FIG. 2a, the illuminating unit 110 may illuminate a region REG1_{λ1} of the object OBJ1 with an illuminating pattern PAT1_{λ1}, which has a wavelength λ₁. The field-of-view FOV1 of the line scan camera CAM1 overlaps the illuminating pattern PAT1_{λ1} and the illuminated region REG1_{λ1}, so as to capture an image of the illuminated region REG1_{λ1}.

The object OBJ1 may move at a relative velocity v_{OBJ1} with respect to the illuminating pattern PAT1. The object OBJ1 may be moved by the actuating unit ACU2. The actuating unit ACU2 may be e.g. a conveyor belt or a robot.

The apparatus 500 may optionally comprise an actuator unit (ACU2) to cause relative motion between the object (OBJ1) and the linear pattern (PAT1).

The spectral imaging method may comprise causing relative motion between the linear pattern (PAT1) and the object OBJ1.

The actuating unit ACU2 may also change angular orientation of the apparatus 500 with respect to the object OBJ1. The actuating unit ACU2 may be e.g. a turret, which may be arranged to rotate the apparatus 500 with respect to a stationary object OBJ1.

SX, SY, and SZ denote orthogonal directions. The longitudinal direction SY may be parallel with the direction of movement of the object OBJ1. The linear pattern PAT1 may be substantially parallel with the transverse direction SX. SZ may denote the vertical direction.

The directions SX, SY, and SZ are associated with the coordinate system of the apparatus 500. The directions SU and SV are associated with the (moving) coordinate system of the object OBJ1. The direction SU may be parallel with the direction SX. The direction SV may be parallel with the direction SY. The illuminating pattern PAT1 may be stationary with respect to the apparatus 500, wherein the illuminating pattern PAT1 may be stationary with respect to the object OBJ1. Consequently, the illuminating patterns PAT1 and the field-of-view FOV1 may sweep over the moving object OBJ1, so as to obtain spectral images from the different regions REG1 of the object OBJ1.

Referring to FIG. 2b, illuminating unit 110 may sequentially illuminate a plurality of adjacent regions REG1_{λ1}, REG1_{λ2}, REG1_{λ3}, . . . REG1_{λN} of the object OBJ1. The line scan camera CAM1 may sequentially capture images IMG1_{λ1}, IMG1_{λ2}, IMG1_{λ3}, . . . IMG1_{λN} of the illuminated regions REG1_{λ1}, REG1_{λ2}, REG1_{λ3}, . . . REG1_{λN}, at different times t₁, t₂, t₃ . . . t_{N}.

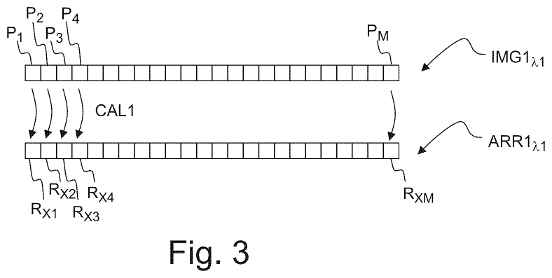

Referring to FIG. 3, the apparatus 500 may be arranged to determine e.g. spectral reflectance values R_{X1}, R_{X2}, R_{X3}, . . . R_{XM} from image pixel values of a captured spectral image IMG1_{λ1} by using calibration data CAL1.

The symbol ARR1_{λ1} denotes an array of spectral reflectance values R_{X1}, R_{X2}, R_{X3}, . . . R_{XM} for different transverse positions x₁, x₂, x₃, . . . x_{M} at the wavelength λ1. The array ARR1_{λ1} may correspond to a linear region REG1_{λ1} of the object OBJ1, which was illuminated with a linear pattern PAT1_{λ1} of wavelength λ1. Said region REG1_{λ1} moves together with the object OBJ1 after the image IMG1λ1 of said region has been captured. The distance between the longitudinal position of the illuminated region REG1_{λ1} and the subsequent illuminating linear patterns PAT1 may be determined e.g. by multiplying the relative velocity v_{OBJ1} of the object (OBJ1) with the difference (t−t₁) between the current time t and the time (t₁) of generating the illuminating pattern PAT1_{λ1} of the wavelength λ1.

The control unit CNT1 may be configured to determine e.g. spectral reflectance values R_{X1}, R_{X2}, R_{X3}, . . . R_{XM} from image pixel values of a captured spectral image IMG1_{λ1} by using calibration data CAL1. The captured image may represent e.g. the wavelength λ1, and also the determined spectral reflectance values R_{X1}, R_{X2}, R_{X3}, . . . R_{XM} may represent the same wavelength λ1. The calibration data CAL1 may be wavelength-specific and/or position-specific. The symbol R_{X1} may denote a spectral reflectance at a transverse position x1.

The apparatus 500 may also be arranged to measure spatial distribution of spectral reflectance of the object OBJ1.

The control unit (CNT1) may be configured to determine spectral reflectance values (Rₓ₁) from pixel values of a captured image (IMG1_{λ1}) by using calibration data (CAL1).

The apparatus 500 may be arranged to measure spatial distribution of spectral transmittance of the object OBJ1.

The apparatus may be arranged to measure spatial distribution of scattering cross section of the object OBJ1, at a plurality of different wavelengths.

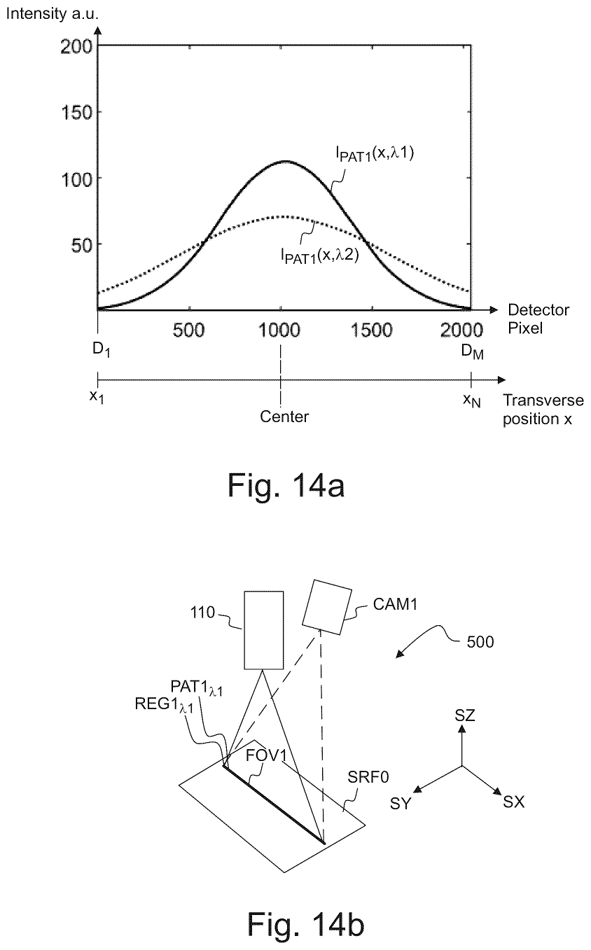

The control unit (CNT1) may also be configured to determine calibration data (CAL1) from captured images (IMG1_{λ1}, (IMG1_{λ2}) of a reference surface (SRF0, see FIG. 14b).

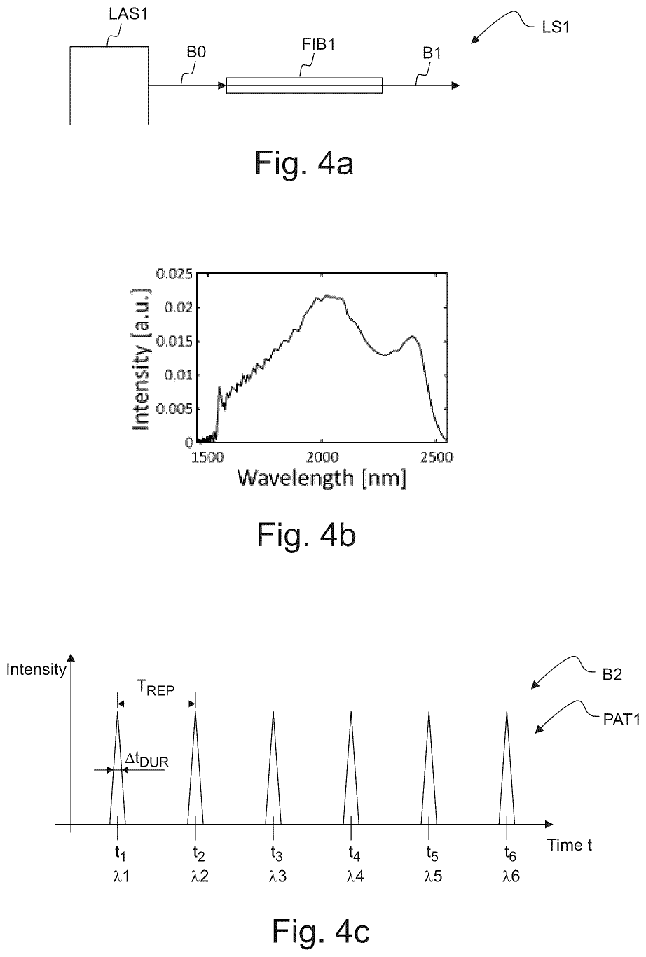

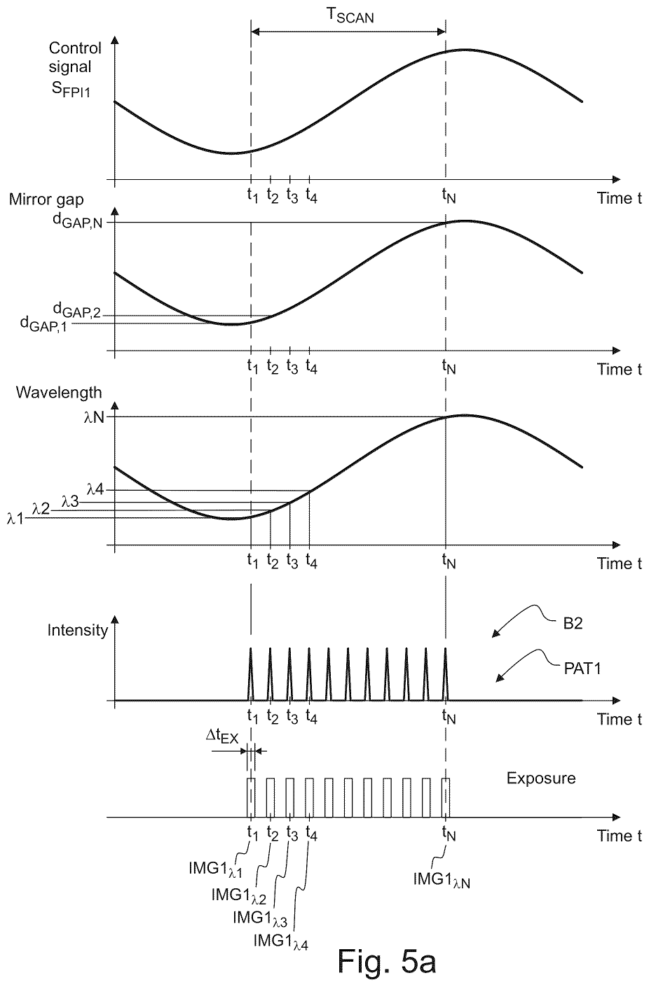

Referring to FIG. 4a, the broadband light source LS1 may comprise e.g. a seed laser LAS1 and an optical fiber FIB1, to repetitively generate a broadband light pulses B1. The duration of a single broadband pulse may be e.g. 10 ns or less. The light source (LS1) may comprise a laser light source (LAS1).

The broadband light source LS1 may comprise a laser light source LAS1 to generate primary light pulses B0. The broadband light source LS1 may comprise an optical fiber FIB1 to form the broadband light pulses B1 from the primary light pulses B0 by nonlinear optical processes. The bandwidth of the broadband light pulses B1 may be arranged to cover the spectral tuning range of the Fabry-Perot interferometer FPI1.

FIG. 4b shows, by way of example, a spectrum of broadband light pulses.

FIG. 4c shows, by way of example, timing and duration of narrowband light pulses. The illuminating patterns have the same timing and duration as the narrowband light pulses. T_{REP} denotes the time period between consecutive light pulses. Δt_{DUR} denotes the duration of a single light pulse.

The broadband laser source LS1 may be arranged to generate and radiate multiple broadband laser pulses B1 with a repetition rate 1/T_{REP} and a pulse duration Δt_{DUR}.

The repetition rate of the light pulses B1, B2 is equal to 1/T_{REP}. The ratio of the time period T_{REP} to the duration Δt_{DUR} of a single light pulse may be e.g. greater than 5.

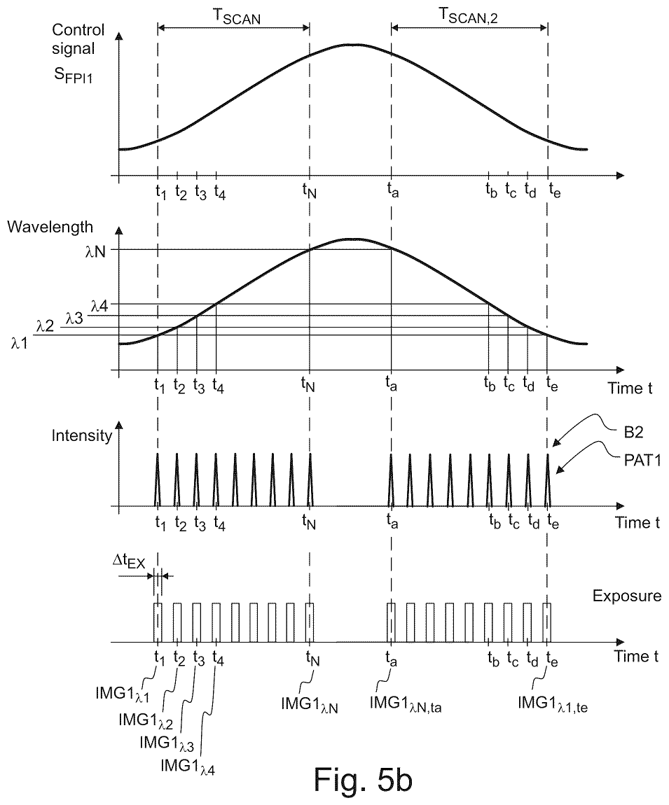

Referring to FIG. 5a, the mirror gap of the Fabry-Perot interferometer may be controlled according to a control signal S_{FPI1}. The control signal S_{FPI1} may be e.g. a control voltage, which is applied to the actuators ACU1 of the Fabry-Perot interferometer. The wavelength of the narrowband light pulses depends on the mirror gap and on the control voltage. The control voltage may be provided by a signal source. The signal source may be implemented e.g. by the control unit CNT1. The control signal S_{FPI1} may be provided by the control unit CNT1. The control voltage may have e.g. a sinusoidal waveform or a sawtooth waveform.

The control voltage may be varied so as to form narrowband light pulses of different wavelengths λ1, λ2, λ3, λ4, . . . λN, at different times t₁, t₂, t₃, t₄, . . . t_{N}.

The illuminating unit 110 may be arranged to sequentially form a plurality of illuminating patterns PAT1 at different wavelengths λ₁, λ₂, . . . λ_{N} by forming the narrowband light pulses B2 with the Fabry-Perot interferometer FPI1, and by changing the mirror gap d_{GAP} of the Fabry-Perot interferometer FPI1.

The mirror gap d_{GAP} may be changed e.g. from a first value (d_{GAP,1}) to a second value (d_{GAP,N}) during a scanning time period (T_{SCAN}).

The apparatus 500 may be arranged to operate such that the mirror gap (d_{GAP}) is changed from a first value (d_{GAP,1}) to a second value (d_{GAP,N}) during a scanning time period (T_{SCAN}), wherein the scanning time period (T_{SCAN}) is shorter than 100 ms, the number of narrowband light pulses (B2) formed at different wavelengths (λ) during the scanning time period (T_{SCAN}) is greater than 10, the number of images (IMG1) captured at the different wavelengths (λ) during the scanning time period (T_{SCAN}) is greater than 10, and wherein capturing of the images (IMG1) is synchronized with the narrowband light pulses (B2).

The Fabry-Perot interferometer (FPI1) may be arranged to have a first mirror gap (d_{GAP,1}) at a first time (t₁) to form a first narrowband light pulse (B2) which has a first wavelength (λ₁), the illuminating unit (110) may be arranged to illuminate a first linear region (PAT1_{λ1}) of the object (OBJ1) with a first linear pattern (PAT1_{λ1}) having the first wavelength (λ₁), the line scan camera (CAM1) may be arranged to capture an image (IMG1_{λ1}) of the first linear region (PAT1_{λ1}) illuminated with the first linear pattern (PAT1_{λ1}), the Fabry-Perot interferometer (FPI1) may be arranged to have a second mirror gap (d_{GAP,2}) at a second time (t₂) to form a second narrowband light pulse (B2) which has a second wavelength (λ₂), the illuminating unit (110) may be arranged to illuminate a second linear region (PAT1_{λ2}) of the object (OBJ1) with a second linear pattern (PAT1_{λ2}) having the second wavelength (λ₂), the line scan camera (CAM1) may be arranged to capture an image (IMG1_{λ2}) of the second linear region (PAT1_{λ2}) illuminated with the second linear pattern (PAT1_{λ2}).

The first linear region (PAT1_{λ1}) and the second linear region (PAT1_{λ2}) are illuminated at different times (t₁, t₂), and the object OBJ1 may be arranged to move such that the first linear region (PAT1_{λ1}) and the second linear region (PAT1_{λ2}) are at different positions in the longitudinal direction SU with respect to the object OBJ1.

The repetition rate of the light pulses B1, B2 may be e.g. greater than or equal to 1 kHz, greater than or equal to 10 kHz, or even greater than or equal to 100 kHz.

The rate of capturing images with the line scan camera CAM1 may be e.g. greater than or equal to 1 kHz, greater than or equal to 10 kHz, or even greater than or equal to 100 kHz.

The Fabry-Perot interferometer FPI1 may be arranged to scan over a wavelength scanning range from λ1 to λN at a fast rate. In particular, the mirror gap d_{GAP} may be changed without stopping the movement of the mirror M2 of the Fabry-Perot interferometer FPI1. The mirror gap d_{GAP} may be changed without stopping the movement of the mirror M2 at the times t₁, t₂, . . . t_{N} of the light pulses B2.

The illuminating unit 110 may be arranged to generate a plurality of narrowband light pulses (B2) at different wavelengths (λ1, λ2, . . . λN) by changing the mirror gap (d_{GAP}) of the Fabry-Perot interferometer (FPI1) during a scanning time period (T_{SCAN}), wherein the movement of the moving mirror (M2) of the Fabry-Perot interferometer (FPI1) is not stopped during the scanning time period (T_{SCAN}).

The mirror M2 of the Fabry-Perot interferometer FPI1 may be moved without stopping the movement of the mirror M2 such that the wavelength of each generated narrowband light pulse B2 may be different from the wavelength of the previous narrowband light pulse B2, during the scanning time period T_{SCAN}.

The timing of the light pulses B2 may be matched to the timing of capturing the images IMG1 with the line scan camera CAM1.

The lowermost part of FIG. 5a shows exposure times of image sensor SEN1 of the line scan camera CAM1. The symbol Δt_{EX} denotes the exposure time of a single captured image IMG1.

Each image frame IMG1 captured by line scan camera CAM1 may be illuminated with a single light pulse formed by the illuminating unit 110. The line scan camera CAM1 may be arranged to capture the spectral images IMG1 such that only one narrowband light pulse B2 at a single wavelength (e.g. λ1) contributes to the exposure of a single captured spectral image IMG1, which represents said wavelength (e.g. λ1).

In an embodiment, the rate of capturing images with the line scan camera CAM1 may be equal to repetition rate of the light pulses.

In an embodiment, the rate of capturing images with the line scan camera CAM1 may also be lower than repetition rate of the light pulses.

In an embodiment, the rate of capturing images with the line scan camera CAM1 may also be higher than repetition rate of the light pulses, e.g. in order to capture dark images.

Referring to FIG. 5b, a plurality of first light pulses B2 may be generated during a first scanning time period T_{SCAN} without stopping the movement of the mirror M2, and a plurality of images IMG1 may be captured during the first scanning time period T_{SCAN}. Image capturing may be synchronized with the light pulses.

The direction of movement of the mirror M2 may be reversed after the first scanning time period T_{SCAN}. A plurality of second light pulses B2 may be generated during a second scanning time T_{SCAN,2} without stopping the movement of the mirror M2, and a plurality of second images IMG1 may be captured during the second scanning time period T_{SCAN,2}. Light pulses may be generated e.g. at times tₐ, t_{b}, t_{c}, t_{d}, tₑ. Image capturing may be synchronized with the light pulses. For example, an image IMG1_{λN,ta} may be captured at a time tₐ, when the illuminating pattern has the wavelength λN. For example, an image IMG1_{λ1,te} may be captured at a time tₑ, when the illuminating pattern has the wavelength λ1.

Light pulses B2 may be generated, and images IMG1 may be captured during a plurality of consecutive scanning time periods T_{SCAN}, T_{SCAN,2}, so as to obtain spectral data from several illuminated regions REG1 of the object OBJ1.

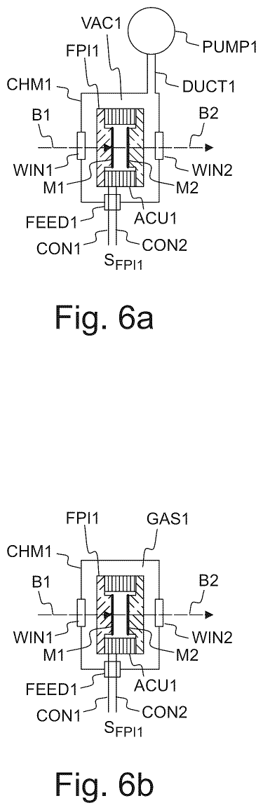

Referring to FIG. 6a, the Fabry-Perot interferometer may be arranged to operate in a vacuum VAC1, so as to facilitate movements of the mirror M2. The presence of ambient air may disturb or slow down the movement of the mirror M2. The Fabry-Perot interferometer FPI1 may be arranged to operate at a reduced pressure, so as to reduce of avoid an effect of ambient gas on the movement of the mirror M2. In particular, the Fabry-Perot interferometer FPI1 may be arranged to operate in a vacuum VAC1. The absolute pressure of the vacuum VAC1 may be e.g. lower than 10 kPa.

The Fabry-Perot interferometer may be positioned in a vacuum chamber CHM1. The vacuum chamber CHM1 may optionally have optical feedthroughs WIN1, WIN2 for transmitting light pulses B1, B2 to the Fabry-Perot interferometer and/or from the Fabry-Perot interferometer. The vacuum chamber CHM1 may optionally have electrical feedthroughs FEED1 for coupling a control voltage S_{FPI1} to the actuators ACU1 of the Fabry-Perot interferometer. The signal S_{FPI1} may be applied to the one or more actuators ACU1 e.g. via conductors CON1, CON2.

The vacuum chamber CHM1 may be arranged to have a permanent vacuum VAC1. The vacuum chamber CHM1 may also be optionally connected to a vacuum pump PUMP1 via a duct DUC1, so as to provide the vacuum during operation. The internal pressure of the vacuum chamber CHM1 may be reduced by using the vacuum pump, e.g. so that the absolute pressure is lower than 10 kPa during operation of the apparatus 500.

The Fabry-Perot interferometer (FPI1) may be positioned in a vacuum chamber (CHM1), wherein the absolute pressure of the vacuum chamber (CHM1) is arranged to be smaller than 10 kPa.

Referring to FIG. 6b, the Fabry-Perot interferometer may be arranged to operate in a gas GAS1, which has low density, so as to facilitate movements of the mirror M2. In particular, the density of the gas GAS1 may be lower than the density of ambient air at normal pressure and temperature. The gas GAS1 may be e.g. helium or hydrogen. The gas GAS1 may be contained in a chamber CHM1.

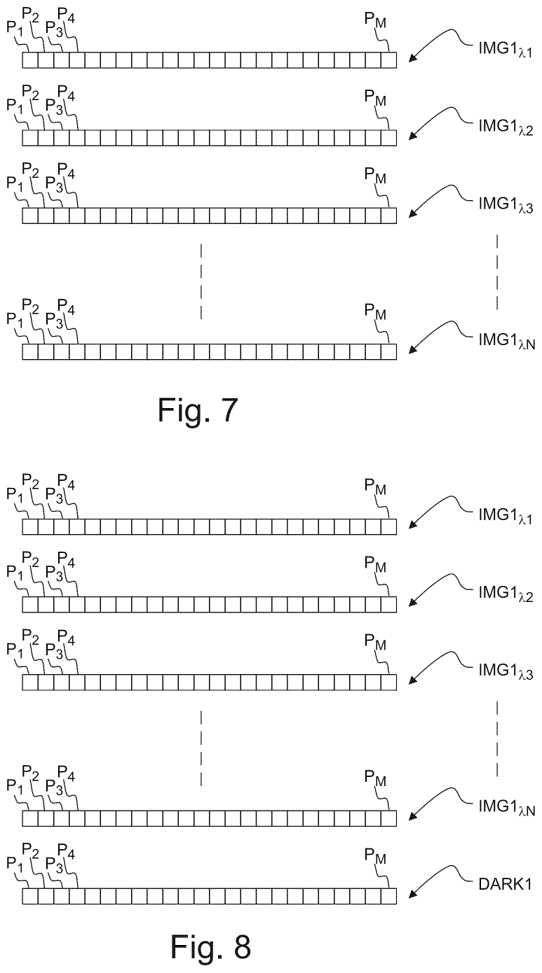

Referring to FIG. 7, the apparatus 500 may sequentially capture a plurality of images IMG1_{λ1}, IMG1_{λ2}, IMG1_{λ3}, . . . IMG1_{λN}, which represent different wavelength λ1, λ2, λ3, . . . λN.

Consecutive linear images IMG1_{λ1}, IMG1_{λ2}, IMG1_{λ3}, . . . IMG1_{λN} of the object, as captured by the line scan camera CAM1, may represent different wavelengths λ1, λ2, . . . λN. Each image may be captured when the object is illuminated with a linear pattern, which has a different wavelength λ1, λ2, . . . λN.

In an embodiment, one captured image frame may be illuminated with one pulse from the light source LS1.

Referring to FIG. 8, the line scan camera CAM1 of the apparatus 500 may also be arranged capture one or more dark image DARK1. The dark image may be captured e.g. without illumination. The same dark image may be used to compensate background for several captured images, which represent the different wavelengths λ1, λ2, . . . λN.

A dark image may be captured without illumination. For example, the broadband light source LS1 may be arranged to shut down momentarily for capturing a dark image.

For example, the line-scan camera may be arranged to capture a dark image during a time period where the broadband light source LS1 does not generate a light pulse.

For example, the line-scan camera may be arranged to capture a dark image when the wavelength of the illuminating linear pattern is outside the spectral detection range of the line-scan camera.

The same dark image DARK1 may be used to compensate background for several captured images, which represent the different wavelengths λ1, λ2, . . . λN.

The line scan camera (CAM1) may be arranged to capture a dark image (DARK1) when the object (OBJ1) is not illuminated with a linear pattern (PAT1), or when the wavelength (λ) of the linear pattern (PAT1) is outside the spectral detection range of the line scan camera (CAM1).

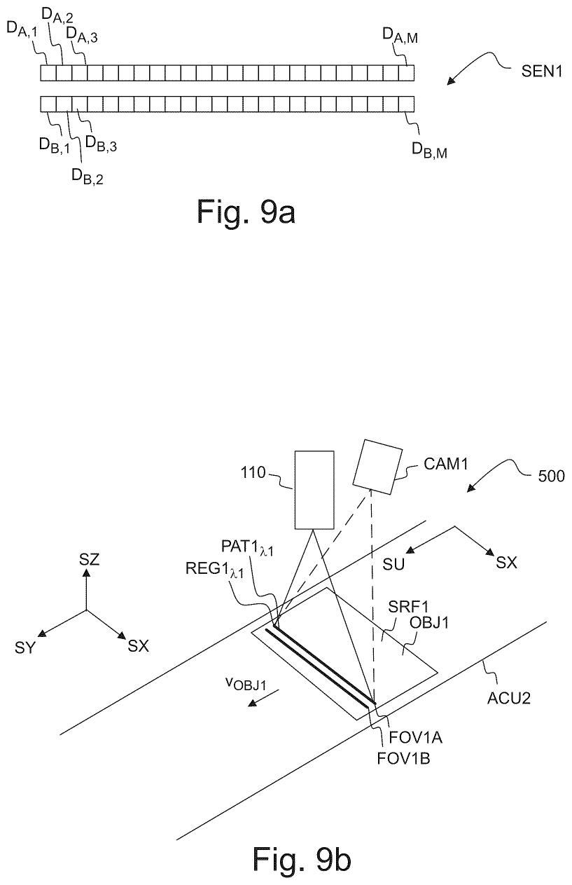

Referring to FIG. 9a, the image sensor SEN1 of the line scan camera CAM1 may comprise a first active row of detector pixels D_{A,1}, D_{A,2}, D_{A,3}, . . . D_{A,M}, and a second active row of detector pixels D_{B,1}, D_{B,2}, D_{B,3}, . . . D_{A,M}. The second row may be used e.g. for measuring dark images. The number of active rows of detector pixels may be e.g. 2, 3, 4, or 5. The small number of active rows may allow reading the image data from the sensor at a fast rate.

The image sensor SEN1 of the line scan camera CAM1 may comprise e.g. a 2×M array of active light-detecting pixels. The number M may be e.g. in the range of 50 to 10000.

The image sensor SEN1 of the line scan camera CAM1 may comprise e.g. a 3×M array of active light-detecting pixels. The number M may be e.g. in the range of 50 to 10000.

The image sensor (SEN1) of the line scan camera (CAM1) may comprise two rows of detector pixels (D). The two rows may be arranged to capture images simultaneously. In an embodiment, the method may also comprise averaging pixel values of the same transverse position in the two images captured by the two rows of detector pixels.

Referring to FIG. 9b, the different rows of the detector pixels may simultaneously have different field-of-views on the object OBJ1. For example, the first row may have a first field-of view FOV1A, and the first row may have a second field-of view FOV1B.

Two rows of detector pixels may be arranged to capture images simultaneously. In an embodiment, a first row of detector pixels may correspond to a first field-of-view, which overlaps the region, which is illuminated with the linear pattern. A second row of detector pixels may correspond to a second different field-of-view, which is outside the region, which is illuminated with the linear pattern. The second row of detector pixels may be arranged e.g. to capture a dark image. The dark image may be used for compensating the background of the first image, which is captured by using the first row of detector pixels.

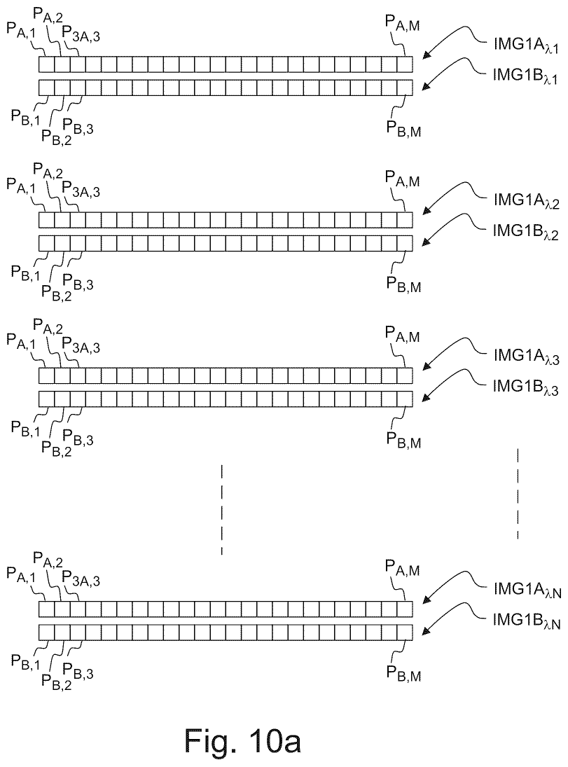

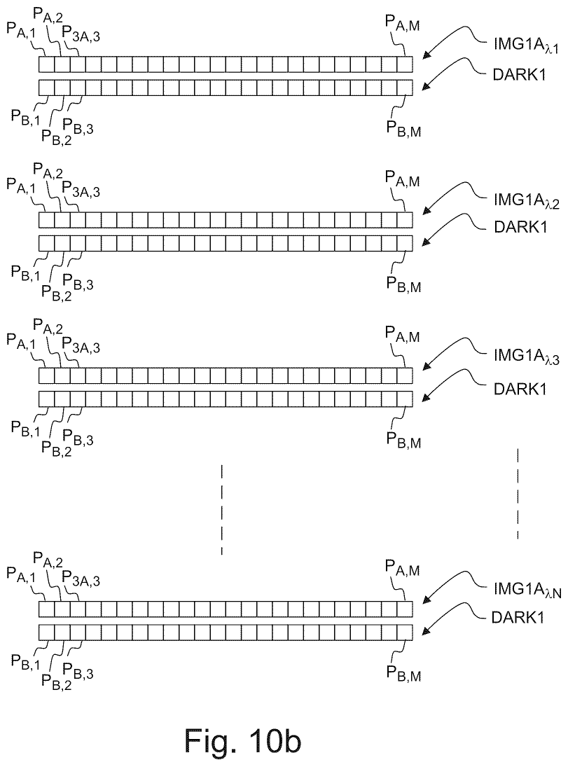

Referring to FIG. 10a, the different rows of the detector pixels may simultaneously capture several images IMG1A_{λ1}, IMG1B_{λ1}, which may represent the same wavelength λ1.

Referring to FIG. 10b, a first row of detector pixels may be used to capture spectral images IMG1A_{λ1}, IMG1A_{λ2}, IMG1A_{λ3}, . . . IMG1A_{λN}. The second row of detector pixels may be capture dark images DARK1. A spectral image IMG1A_{λ1} and a dark image IMG1 may be captured simultaneously.

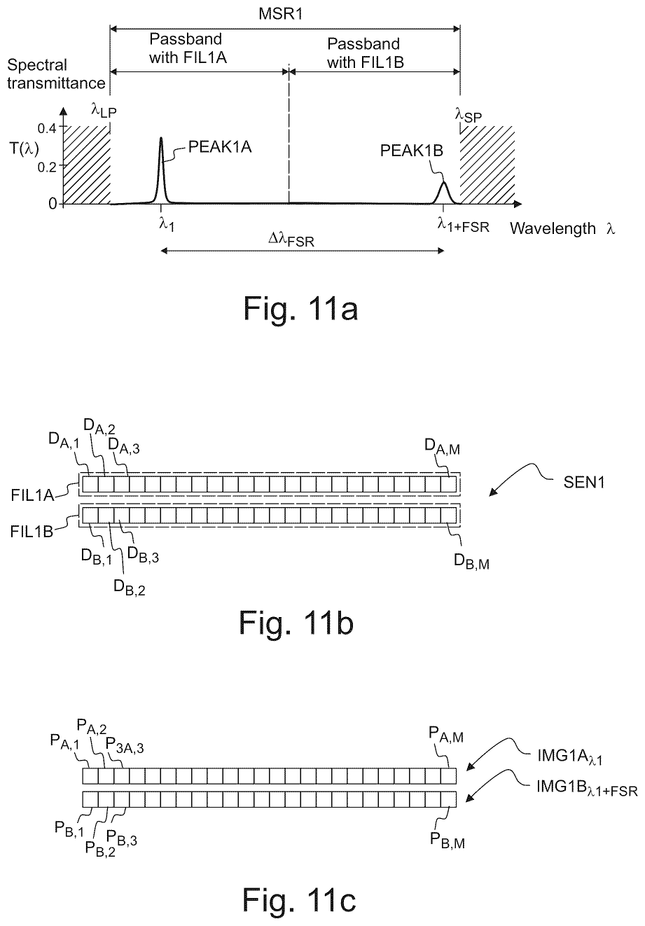

Referring to FIG. 11a, the apparatus 500 may be arranged to operate such that the spectral measurement range of the apparatus 500 comprises e.g. one or more spectral transmittance peaks PEAK1A, PEAK1B of the Fabry-Perot interferometer.

When using a single spectral transmittance peaks PEAK1A, the illuminating pattern PAT1 has only one single wavelength (e.g. λ1), and the captured image IMG1 represents said single wavelength.

When using the two spectral transmittance peaks PEAK1A, the illuminating pattern PAT1 has two wavelengths. The first spectral transmittance peak PEAK1A is at a first wavelength λ1, and the second spectral transmittance peak PEAK1B is at a second wavelength λ_{1+FSR}. FSR denotes the free spectral range Δλ_{FSR} of the Fabry-Perot interferometer FPI1.

Referring to FIG. 11b, a first row of detector pixels may have a first optical filter FIL1A to provide a first spectral detection range for the first row of detector pixels. A second row of detector pixels may have a second optical filter FIL1B to provide a second different spectral detection range for the second row of detector pixels. The first filter FIL1A may be e.g. an optical low pass filter, and the second filter FIL1B may be e.g. an optical high pass filter.

At least one row of detector pixels of the line scan camera (CAM1) may comprise an optical filter (FIL1A) such that the spectral sensitivity of a first row of detector pixels (D_{A}) is different from the spectral sensitivity of a second row of detector pixels (D_{B}).

Referring to FIG. 11c, the line scan camera CAM1 may comprise two active rows of detector pixels such that the image IMG1A obtained from the first row is captured by using light transmitted via the first spectral transmittance peak PEAK1A so that light transmitted via the second spectral transmittance peak PEAK1B does not contribute to the image IMG1A. The second image IMG1B obtained from the second row is captured by using light transmitted via the second spectral transmittance peak PEAK1B so that light transmitted via the first spectral transmittance peak PEAK1A does not contribute to the image IMG1B. The first image IMG1A may represent the wavelength λ1, and the second image IMG1B may represent the wavelength λ_{1+FSR}. The images IMG1A and IMG1B may be captured simultaneously or substantially simultaneously.

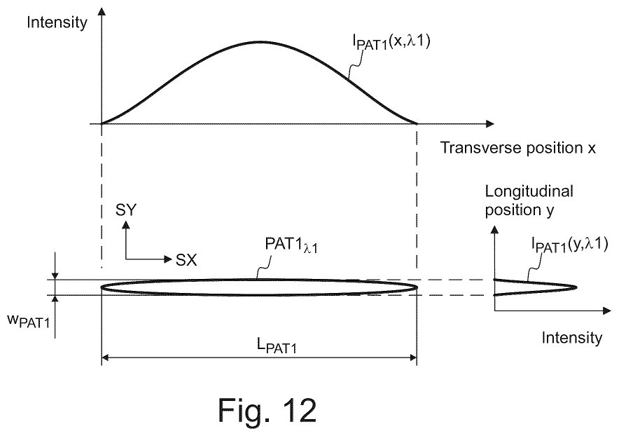

FIG. 12 shows, by way of example, the spatial intensity distribution of an illuminating linear pattern PAT1 in the transverse direction, and the spatial intensity distribution of the illuminating linear pattern in the longitudinal direction (i.e. in the direction of the movement of the object). The linear pattern PAT1 may have a width w_{PAT1} in the longitudinal direction (SY) and a length L_{PAT1} in the transverse direction (SX).

The dimension L_{PAT1} of the illuminating pattern PAT1 is significantly greater than the dimension w_{PAT1}. The ratio L_{PAT1}/w_{PAT1} may be e.g. greater than 10, greater than 100, or even greater than 1000. The ratio L_{PAT1}/w_{PAT1} may be e.g. in the range of 10 to 10000.

The dimension (w_{PAT}) of the illuminating pattern PAT1 in the longitudinal direction SY may be substantially smaller than the dimension of the field-of-view FOV1 in the direction SY, so as to define the spatial resolution according to the dimension (w_{PAT}) of the illuminating pattern PAT1.

The spatial intensity distribution of the illuminating linear pattern PAT1 may be different for each illuminating linear pattern PAT1 at each different wavelength λ1, λ2, λ3, . . . λN. The spatial intensity distribution of the illuminating linear pattern PAT1 may be wavelength-specific. The effect of the wavelength-specific may be compensated e.g. by using wavelength-specific calibration data CAL1. For example, spectral reflectance distributions may be calculated from the captured images IMG1 by using wavelength-specific calibration data CAL1.

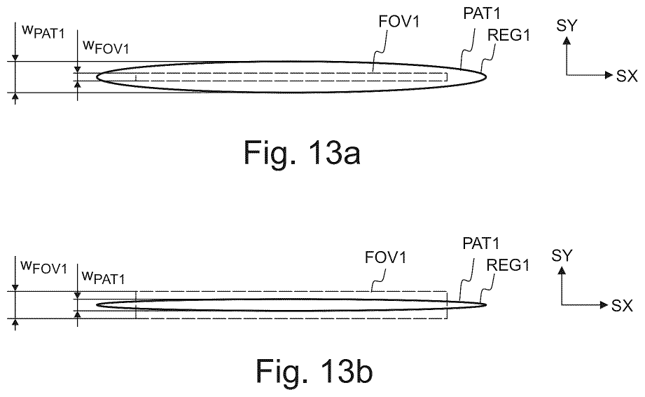

Referring to FIG. 13a, the field-of-view FOV1 of the line-scan camera CAM1 may overlap the region REG1, which is illuminated by the linear pattern PAT1. The field-of-view FOV1 of the line-scan camera CAM1 has a dimension w_{FOV1} in the longitudinal direction SY. The linear pattern PAT1 has a dimension w_{PAT1} in the longitudinal direction SY. The dimension w_{FOV1} of the field-of-view FOV1 may be smaller than the dimension w_{PAT1} of the linear pattern PAT1, and the line-scan camera CAM1 may determine the spatial resolution in the longitudinal direction SY.

Referring to FIG. 13b, the field-of-view FOV1 of the line-scan camera CAM1 may overlap the region REG1, which is illuminated by the linear pattern PAT1. The dimension w_{PAT1} of the linear pattern PAT1 may be smaller than the dimension w_{FOV1} of the field-of-view FOV1, and the beam-shaping optics OPT1 of the illuminating unit 110 may determine the spatial resolution in the longitudinal direction SY. Determining the spatial resolution by the linear pattern PAT1 may e.g. reduce an effect of the vertical position of the object OBJ1 on the intensity detected by the line scan camera CAM1.

In particular, the dimension w_{PAT1} may be smaller than the dimension w_{FOV1}, and the light beam acting as the linear pattern PAT1 may be collimated or substantially collimated such that the intensity distribution I_{PAT1}(x,λ1) of the illuminating pattern PAT1 on the illuminated region REG1 may be substantially independent of the distance between the illuminating unit 110 and the object OBJ1.

Referring to FIG. 14a, the spatial intensity distribution of the linear pattern PAT1 may have e.g. a Gaussian shape. The spatial intensity distribution I_{PAT1}(x,λ1) at a first wavelength λ1 may be different from the spatial intensity distribution I_{PAT1}(x,λ2) at a second wavelength λ2.

A first detector pixel D₁ of the sensor SEN1 may be arranged to detect light from a transverse position x₁ on the surface SRF1 of the object OBJ1. The detector pixel D₁ may correspond to the transverse position x₁. A detector pixel D_{M} of the sensor SEN1 may be arranged to detect light from a transverse position x_{M} on the surface SRF1 of the object OBJ1. The detector pixel D_{M} may correspond to the transverse position x_{M}.

Referring to FIG. 14b, the apparatus 500 may be arranged to obtain calibration data CAL1 by illuminating a reference surface SRF0 with the linear pattern PAT1, and capturing an image IMG1 of the illuminated region REG1. Wavelength-specific calibration data CAL1 for the wavelength λ1 may be obtained by illuminating the reference surface SRF0 with the linear pattern PAT1 at the wavelength λ1, and capturing an image IMG1λ1 of the illuminated region REG1. The calibration data CAL1 may be stored e.g. in a memory MEM3. The control unit CNT1 may be arranged to determine the calibration from an image IMG1 of the illuminated region REG1 of the reference surface SRF0. The reference surface SRF0 may be e.g. a white surface or a grey surface, which has known reflectance.

At a later stage, the calibration data CAL1 may be retrieved from the memory MEM3, and the calibration data CAL1 may be used for determining reflectance values from the pixel values of one or more captured images IMG1 of illuminated regions REG1 of an object OBJ1.

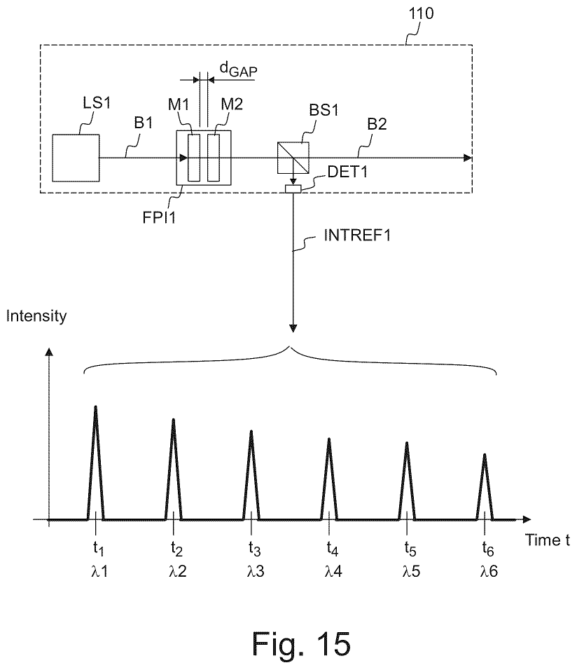

Referring to FIG. 15, the apparatus 500 may be arranged to measure the intensity and/or energy of the generated light pulses B2. A part of the light of the light pulses B2 may be coupled to the reference detector DET1 via a beam splitter BS1. The reference detector DET1 may form a reference signal INTREF1, which is indicative of the intensity and/or energy of the generated light pulses B2. The reference signal INTREF1 may be used e.g. as feedback signal to stabilize the operation of the illuminating unit 110. The reference signal INTREF1 may be used e.g. for compensating an effect of variation of the intensity and/or energy of the generated light pulses B2 to the measured pixel values.

The illuminating unit (110) may comprise a beamsplitter (BS1), and a reference detector (DET1), wherein a part of the light of the light pulses (B1, B2) may be directed to the reference detector (DET1) via the beamsplitter (BS1) so as to measure the energy and/or intensity of the light pulses (B1, B2).

The method may comprise measuring the intensity and/or energy of each generated light pulse B2, at each different wavelength λ1, λ2, λ3, . . . λN.

The wavelength-specific calibration data CAL1 may be determined, stored, and used separately for each different wavelength λ1, λ2, λ3, . . . λN. The calibration CAL1 may be stored in a memory (MEM3) as a data matrix, or as parameters of a regression function. For example, the spatial intensity distribution of the illuminating pattern PAT1 may be substantially gaussian, and the calibration CAL1 may be stored in the memory MEM3 as parameters of a gaussian regression function.

### REFERENCE SIGNS

500 Spectral imaging apparatus
LS1 Broadband light source
FPI1 Fabry-Perot interferometer
M1 First mirror
M2 second mirror
d_{GAP} mirror gap
λ Wavelength
DET Reference detector for monitoring pulse energy and/or intensity
BS1 Beam splitter
INTREF1 Signal from the reference detector
OPT1 Beam shaping optics
OBJ1 Object
v_{OBJ1} Relative velocity of object
SRF1 Surface of the object
110 Illuminating unit
CAM1 line scan camera
LNS1 Imaging optics of camera
SEN1 Image sensor of camera
D Detector pixel of image sensor
Δt_{EX} exposure time of detector pixels
IMG1 Captured image
P Pixel of captured image
DARK1 Dark image
PAT1 Illuminating linear pattern
L_{PAT1} Transverse dimension of illuminating pattern
w_{PAT1} Longitudinal dimension of illuminating pattern
I_{PAT}(x,λ1) Spatial intensity distribution of illuminating pattern at wavelength l
w_{FOV1} Longitudinal dimension of field-of-view
REG1 Illuminated region
CNT1 Control unit
LAS1 Seed laser
FIB1 Optical fiber
B0 Primary laser pulse
B1 Broadband light pulse
B2 Narrowband light pulse
CHM1 Vacuum chamber
VAC1 Vacuum
GAS1 Gas
PUMP1 Vacuum pump
DUC1 Duct
WIN1 Window of vacuum chamber
WIN2 Window of vacuum chamber
FEED1 Electrical feedthrough
CON1 Electrical conductor
CON2 Electrical conductor
FOV1 Field-of-view
FOV1A Field-of-view of the first row of detector pixels
FOV1B Field-of-view of the second row of detector pixels
D_{A} Detector pixel of the first row of detector pixels
D_{B} Detector pixel of the second row of detector pixels
P_{A} Image pixel captured by the first row of detector pixels
P_{B} Image pixel captured by the second row of detector pixels
FIL1A Optical filter of the first row of detector pixels
FIL1B Optical filter of the second row of detector pixels
MSR1 Measurement spectral range
λ_{LP} First limit of measurement spectral range
λ_{SP} Second limit of measurement spectral range
T(λ) Spectral transmittance
PEAK1A Spectral transmittance peak of Fabry-Perot interferometer
PEAK1B Spectral transmittance peak of Fabry-Perot interferometer
FSR Acronym of free spectral range
Δλ_{FSR} Free spectral range
MEM1 Memory
MEM2 Memory
MEM3 Memory
MEM4 Memory
PROG1 Computer program code
ACU2 Actuating unit
ACU1 Actuator of Fabry-Perot Interferometer
SX transverse direction
SY longitudinal direction
SZ vertical direction
CUBE1 hyperspectral data cube
ARR1 Array of reflectance data
R_{X1} Reflectance at position X1
CAL1 Calibration data
RXTX1 Communication unit
UIF1 User interface
t Time
T_{REP} Time period between consecutive light pulses
Δt_{dUR} Duration of a single pulse
S_{FPI1} Control signal of Fabry-Perot interferometer
T_{SCAN} Scanning time period
SRF0 Reference surface

Various aspects of the invention are illustrated by the following examples:

Example 1. An apparatus (500) for spectral imaging, comprising:
an illuminating unit (110) to illuminate a linear region (REG1) of an object (OBJ1) with a linear pattern (PAT1) formed from a narrowband light pulse (B2), and
a line scan camera (CAM1) to capture an image (IMG1_{λ}) of the illuminated linear region (REG1),

wherein the illuminating unit (110) comprises:
a light source (LS1) to generate broadband light pulses (B1),
a tunable Fabry-Perot interferometer (FPI1) to form the narrowband light pulse (B2) by filtering a broadband light pulse (B1),
beam-shaping optics (OPT1) to form the linear pattern (PAT1) from the narrowband light pulse (B2), the wavelength (λ) of the linear pattern (PAT1) being determined by the mirror gap (d_{GAP}) of the Fabry-Perot interferometer (FPI1), and wherein the apparatus (500) is arranged to change the mirror gap (d_{GAP}) of the Fabry-Perot interferometer (FPI1).

Example 2. The apparatus (500) of example 1, being arranged to generate a plurality of narrowband light pulses (B2) at different wavelengths (λ1, λ2, . . . λN) by changing the mirror gap (d_{GAP}) of the Fabry-Perot interferometer (FPI1) during a scanning time period (T_{SCAN}), wherein the movement of the moving mirror (M2) of the Fabry-Perot interferometer (FPI1) is not stopped during the scanning time period (T_{SCAN}).

Example 3. The apparatus of example 1 or 2, wherein the Fabry-Perot interferometer (FPI1) is positioned in a vacuum chamber (CHM1), wherein the absolute pressure of the vacuum chamber (CHM1) is arranged to be smaller than 10 kPa.

Example 4. The apparatus (500) according to any of the examples 1 to 3, wherein the image sensor (SEN1) of the line scan camera (CAM1) comprises only one active row of detector pixels (D).

Example 5. The apparatus (500) according to any of the examples 1 to 3, wherein the image sensor (SEN1) of the line scan camera (CAM1) comprises two rows of detector pixels (D).

Example 6. The apparatus (500) of example 5, wherein at least one row of detector pixels of the line scan camera (CAM1) comprises an optical filter (FIL1A) such that the spectral sensitivity of a first row of detector pixels (D_{A}) is different from the spectral sensitivity of a second row of detector pixels (D_{B}).

Example 7. The apparatus (500) according to any of the examples 1 to 6, being arranged to operate such that the mirror gap (d_{GAP}) is changed from a first value (d_{GAP,1}) to a second value (d_{GAP,N}) during a scanning time period (T_{SCAN}), the scanning time period (T_{SCAN}) is shorter than 100 ms, the number of narrowband light pulses (B2) formed at different wavelengths (λ) during the scanning time period (T_{SCAN}) is greater than 10, the number of images (IMG1) captured at the different wavelengths (λ) during the scanning time period (T_{SCAN}) is greater than 10, and wherein capturing of the images (IMG1) is synchronized with the narrowband light pulses (B2).

Example 8. The apparatus (500) according to any of the examples 1 to 7, wherein the light source (LS1) comprises a laser light source (LAS1).

Example 9. The apparatus (500) according to any of the examples 1 to 8, wherein the illuminating unit (110) comprises a beam splitter (BS1), and a reference detector (DET1), wherein a part of the light of the light pulses (B1, B2) is directed to the reference detector (DET1) via the beam splitter (BS1) so as to measure the energy and/or intensity of the light pulses (B1, B2).

Example 10. The apparatus (500) according to any of the examples 1 to 9, wherein the line scan camera (CAM1) is arranged to capture a dark image (DARK1) when the object (OBJ1) is not illuminated with a linear pattern (PAT1), or when the wavelength (λ) of the linear pattern (PAT1) is outside the spectral detection range of the line scan camera (CAM1).

Example 11. The apparatus (500) according to any of the examples 1 to 10, further comprising an actuator unit (ACU2) to cause relative motion between the object (OBJ1) and the linear pattern (PAT1).

Example 12. The apparatus (500) according to any of the examples 1 to 11, wherein the actuator unit (ACU2) comprises a conveyor belt and/or a robot.

Example 13. The apparatus (500) according to any of the examples 1 to 12, comprising a control unit (CNT1), which is configured to determine spectral reflectance values (Rₓ₁) from pixel values of a captured image (IMG1_{λ1}) by using calibration data (CAL1).

Example 14. The apparatus (500) according to any of the examples 1 to 13, comprising a control unit (CNT1), which is configured to determine calibration data (CAL1) from captured images (IMG1_{λ1}, (IMG1_{λ2}) of a reference surface (SRF0).

Example 15. The apparatus (500) according to any of the examples 1 to 14, wherein the Fabry-Perot interferometer (FPI1) is arranged to have a first mirror gap (d_{GAP,1}) at a first time (t₁) to form a first narrowband light pulse (B2) which has a first wavelength (λ₁), the illuminating unit (110) is arranged to illuminate a first linear region (PAT1_{λ1}) of the object (OBJ1) with a first linear pattern (PAT1_{λ1}) having the first wavelength (λ₁), the line scan camera (CAM1) is arranged to capture an image (IMG1_{λ1}) of the first linear region (PAT1_{λ1}) illuminated with the first linear pattern (PAT1_{λ1}), the Fabry-Perot interferometer (FPI1) is arranged to have a second mirror gap (d_{GAP,2}) at a second time (t₂) to form a second narrowband light pulse (B2) which has a second wavelength (λ₂), the illuminating unit (110) is arranged to illuminate a second linear region (PAT1_{λ2}) of the object (OBJ1) with a second linear pattern (PAT1_{λ2}) having the second wavelength (λ₂), the line scan camera (CAM1) is arranged to capture an image (IMG1_{λ2}) of the second linear region (PAT1_{λ2}) illuminated with the second linear pattern (PAT1_{λ2}).

Example 16. A method for spectral imaging, comprising:
generating broadband light pulses (B1),
forming a narrowband light pulse (B2) from a broadband light pulse (B1) by using a tunable Fabry-Perot interferometer (FPI1),
forming a linear pattern (PAT1) from the narrowband light pulse (B2) by using beam-shaping optics (OPT1),
illuminating a linear region (REG1) of an object (OBJ1) with the linear pattern (PAT1),
capturing an image (IMG1_{λ}) of the illuminated linear region (REG1), and
changing the mirror gap (d_{GAP}) of the Fabry-Perot interferometer (FPI1).

Example 17. The method of example 16 comprising causing relative motion between the object (OBJ1) and the linear pattern (PAT1).

For the person skilled in the art, it will be clear that modifications and variations of the devices and methods according to the present invention are perceivable. The figures are schematic. The particular embodiments described above with reference to the accompanying drawings are illustrative only and not meant to limit the scope of the invention, which is defined by the appended claims.

1. An apparatus for spectral imaging, comprising:
an illuminating unit to illuminate a linear region of an object with a linear pattern formed from a narrowband light pulse, and
a line scan camera to capture an image of the illuminated linear region,
wherein the illuminating unit comprises:
a light source to generate broadband light pulses,
a tunable Fabry-Perot interferometer to form the narrowband light pulse by filtering a broadband light pulse,
beam-shaping optics to form the linear pattern from the narrowband light pulse, the wavelength of the linear pattern being determined by the mirror gap of the Fabry-Perot interferometer, and
wherein the apparatus is arranged to change the mirror gap of the Fabry-Perot interferometer.

2. The apparatus of claim 1, being arranged to generate a plurality of narrowband light pulses at different wavelengths by changing the mirror gap of the Fabry-Perot interferometer during a scanning time period, wherein the movement of the moving mirror of the Fabry-Perot interferometer is not stopped during the scanning time period.

3. The apparatus of claim 1, wherein the Fabry-Perot interferometer is positioned in a vacuum chamber, wherein the absolute pressure of the vacuum chamber is arranged to be smaller than 10 kPa.

4. The apparatus of claim 1, wherein the image sensor of the line scan camera comprises only one active row of detector pixels.

5. The apparatus of claim 1, wherein the image sensor of the line scan camera comprises two rows of detector pixels.

6. The apparatus of claim 5, wherein at least one row of detector pixels of the line scan camera comprises an optical filter such that the spectral sensitivity of a first row of detector pixels is different from the spectral sensitivity of a second row of detector pixels.

7. The apparatus of claim 1, being arranged to operate such that the mirror gap is changed from a first value to a second value during a scanning time period, the scanning time period is shorter than 100 ms, the number of narrowband light pulses formed at different wavelengths during the scanning time period is greater than 10, the number of images captured at the different wavelengths during the scanning time period is greater than 10, and wherein capturing of the images is synchronized with the narrowband light pulses.

8. The apparatus of claim 1, wherein the light source comprises a laser light source.

9. The apparatus of claim 1, wherein the illuminating unit comprises a beam splitter, and a reference detector, wherein a part of the light of the light pulses is directed to the reference detector via the beam splitter so as to measure the energy and/or intensity of the light pulses.

10. The apparatus of claim 1, wherein the line scan camera is arranged to capture a dark image when the object is not illuminated with a linear pattern, or when the wavelength of the linear pattern is outside the spectral detection range of the line scan camera.

11. The apparatus of claim 1, further comprising an actuator unit to cause relative motion between the object and the linear pattern.

12. The apparatus of claim 1, wherein the actuator unit comprises a conveyor belt and/or a robot.

13. The apparatus of claim 1, comprising a control unit, which is configured to determine spectral reflectance values from pixel values of a captured image by using calibration data.

14. The apparatus of claim 1, comprising a control unit, which is configured to determine calibration data from captured images of a reference surface.

15. The apparatus of claim 1, wherein the Fabry-Perot interferometer is arranged to have a first mirror gap at a first time to form a first narrowband light pulse which has a first wavelength, the illuminating unit is arranged to illuminate a first linear region of the object with a first linear pattern having the first wavelength, the line scan camera is arranged to capture an image of the first linear region illuminated with the first linear pattern, the Fabry-Perot interferometer is arranged to have a second mirror gap at a second time to form a second narrowband light pulse which has a second wavelength, the illuminating unit is arranged to illuminate a second linear region of the object with a second linear pattern having the second wavelength, the line scan camera is arranged to capture an image of the second linear region illuminated with the second linear pattern.

16. A method for spectral imaging, comprising:
generating broadband light pulses,
forming a narrowband light pulse from a broadband light pulse by using a tunable Fabry-Perot interferometer,
forming a linear pattern from the narrowband light pulse by using beam-shaping optics,
illuminating a linear region of an object with the linear pattern,
capturing an image of the illuminated linear region, and
changing the mirror gap of the Fabry-Perot interferometer.

17. The method of claim 16 comprising causing relative motion between the object and the linear pattern.
